(19) United States
(12) Patent Application Publication
(10) Pub. No.: US 2007/0155417 A1
(43) Pub. Date: Jul. 5, 2007

(54) Method and apparatus to facilitate selecting a wireless point-of-attachment opportunity

(76) Inventors: Samuel M. Levenson, Arlington Heights, IL (US); John C. Boot, Clarksburg, MD (US)

Correspondence Address: MOTOROLA, INC., 1303 EAST ALGONQUIN ROAD, IL01/3RD, SCHAUMBURG, IL, 60196, US

(21) Appl. No.: 11/323,615

(22) Filed: Dec. 30, 2005

(51) Int. Cl. H04B 7/00

(52) U.S. Cl. 455/525; 455/509; 455/522

(57) ABSTRACT

When a mobile communication station detects (101) a plurality of available wireless point-of-attachment opportunities (and where at least one of the mobile communication station and at least one of the plurality of available wireless point-of-attachment opportunities is in motion), the mobile communication station selects (102) a given one of the plurality of available wireless point-of-attachment opportunities as a function, at least in part, of an operational context as corresponds to the mobile communication station to thereby provide a selected available wireless point-of-attachment opportunity.

### TECHNICAL FIELD

This invention relates generally to mobile communication stations and more particularly to selecting a particular available wireless point-of-attachment opportunity.

### BACKGROUND

Mobile communication stations of various kinds are known in the art and include, but are not limited to, cellular telephones, wireless email platforms, wireless portable computers (including both laptop and hand held versions), embedded devices and components of various kinds, and so forth. Such devices typically facilitate their wireless communications using one or more available wireless points-of-attachment. The latter may comprise fixed assets or can themselves comprise mobile platforms.

A selection mechanism of some kind is ordinarily provided to facilitate a selection of a particular available wireless point-of-attachment opportunity when a plurality of such opportunities are available to a given mobile communication station (where the term “available” will be understood to refer to an opportunity that the mobile communication station is otherwise authorized or able to engage). In some application settings the mobile communication station plays only a supporting role (or less) with respect to effecting the selection process. In other settings, however, the mobile communication station may have some (or even considerable) latitude in this regard.

A mobile communication station that is capable of making (or at least contributing to) such a selection will often base that selection upon criteria that relates to the radio frequency environment. For example, a given mobile communication station may consider factors such as received signal strength, bit error rates, supported bandwidth, and so forth when selecting a particular available wireless point-of-attachment opportunity. In a typical scenario, the mobile communication station will select a given available wireless point-of-attachment opportunity that exhibits a best radio frequency environment condition (or conditions).

Such an approach works well for many purposes. This approach can be particularly advantageous when simply seeking to ensure that the mobile communication station has the best available communication conditions at that particular moment. There are operating circumstances, however, when such an approach may lead to less than desired results. For example, when at least one of the mobile communication station and the available wireless point-of-attachment opportunity (or opportunities) available for selection is moving, these dynamic conditions can lead to selection of an immediately viable wireless point-of-attachment opportunity that quickly becomes degraded or unavailable. Other problems and/or lost opportunities can also occur.

### BRIEF DESCRIPTION OF THE DRAWINGS

The above needs are at least partially met through provision of the method and apparatus to facilitate selecting a wireless point-of-attachment opportunity described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a top plan schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, when a mobile communication station detects a plurality of available wireless point-of-attachment opportunities (and where at least one of the mobile communication station and at least one of the plurality of available wireless point-of-attachment opportunities is in motion), the mobile communication station selects a given one of the plurality of available wireless point-of-attachment opportunities as a function, at least in part, of an operational context as corresponds to the mobile communication station to thereby provide a selected available wireless point-of-attachment opportunity.

As used herein, “operational context” refers to a context other than the radio frequency environment as corresponds to the wireless communication station. While such considerations as the radio frequency environment may also be used if desired to possibly influence the selection process, in general, by these teachings, the operational context comprises at least another and, perhaps more typically, a predominant consideration. A non-exhaustive listing of illustrative operational contexts might include communicating via available wireless point-of-attachment opportunities that comprise relatively short range resources, communicating with a series of related fixed position available wireless point-of-attachment opportunities, and/or communicating via a particular class of available wireless point-of-attachment opportunities.

So configured, a mobile communication station can make a selection based upon an operational context as applies to that mobile communication station. This, in turn, can permissibly comprise selecting a particular available wireless point-of-attachment opportunity that has less favorable bearer channel conditions than another of a candidate pool of available wireless point-of-attachment opportunities. Although such a result runs contrary to typical prior art methodology, such an approach can provide considerable benefits when deployed in an appropriate setting. These benefits can include, but are not limited to, a wireless resource characterized by longer term availability and stability, avoidance of undue point-of-attachment decision-making events, and/or better support of particular corresponding services, to note but a few. Those skilled in the art will understand and appreciate that such teachings may be particularly helpful and beneficial when applied in the context of a land vehicle.

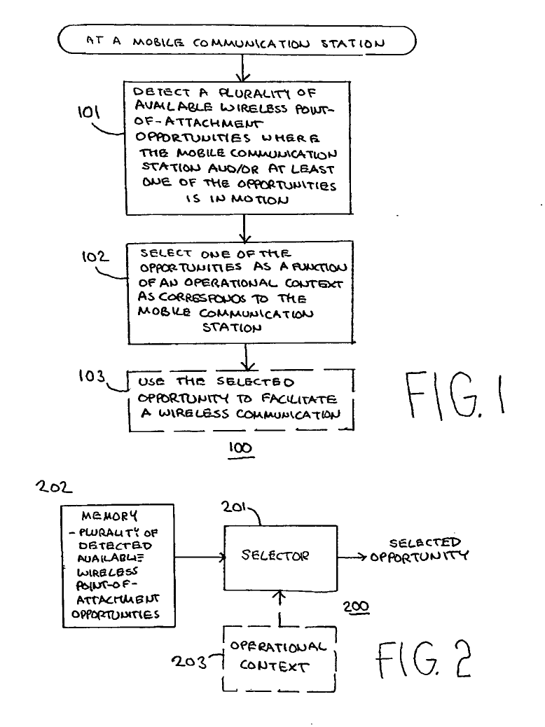

These and other benefits may become clearer upon making a thorough review and study of the following detailed description. Referring now to the drawings, and in particular to FIG. 1, these teachings may be employed by a mobile communication station such as, but not limited to, a handheld mobile communication station or an embedded mobile communication station (as when a processing platform having wireless capability is built into an automobile or a component thereof). Such platforms are generally known in the art and others will no doubt be developed in the future.

Pursuant to the depicted process 100, the mobile communication station detects 101 a plurality of available wireless point-of-attachment opportunities. These available wireless point-of-attachment opportunities may be homogenous with respect to one another or may differ from one another in any of a wide variety of ways. For example, these available wireless point-of-attachment opportunities may differ from one another with respect to supported protocols, supported wireless resource frequencies, encryption capabilities, hand over capability, range, and so forth. It is also possible that one or more of these available wireless point-of-attachment opportunities differs with respect to network administration and/or ownership. The presence and availability of such opportunities can be detected via any of a number of known techniques. As these teachings are not particularly sensitive with respect to the usage or selection of any particular one of these techniques, for the sake of brevity no further elaboration will be provided here regarding such techniques.

By one approach, this process 100 applies when at least one of:

the mobile communication station itself; and

at least one of the available wireless point-of-attachment opportunities;

is in motion. This can occur when the mobile communication station is moving (as when a person carrying the mobile communication station is a passenger in a moving vehicle), when one or more of the available wireless point-of-attachment opportunities is moving (as when one of the available wireless point-of-attachment opportunities is itself installed in a moving vehicle), or when both such circumstances occur.

Under such conditions, this process 100 then provides for selecting 102 a given one of the plurality of available wireless point-of-attachment opportunities as a function, at least in part, of an operational context as corresponds to the mobile communication station. This selection can be solely based upon operational context criteria or can be partially based thereon depending upon the needs and/or requirements of a given application setting.

The particular operational context used for this purpose can also vary with the needs and/or capabilities of a particular context. By one approach the operational context can comprise communicating via wireless point-of-attachment opportunities that comprise relatively short range resources. Examples include, but are not limited to, 802.11(a), 802.11(b), and 802.11(g)-based networks as are known in the art. Another example comprises the Dedicated Short Range Communication (DSRC) context as promulgated under the auspices of the United States Federal Highway Administration.

To illustrate, when the operational context comprises communicating via DSRC resources, the above-described selection can seek to emphasize continuity in anticipating attachment to roadside DSRC beacons notwithstanding the availability of other otherwise acceptable points of attachment that may even exhibit superior radio frequency conditions. In this case the process 100 can tend to urge selection of a DSRC resource even when the latter may exhibit relatively poor radio frequency conditions. This selection, in turn, can yield longer-term better performance for the user because the DSRC operational context will be better maintained by this approach.

By another approach, the operational context can comprise communicating with a series of related fixed position wireless point-of-attachment opportunities. This example is similar to the DSRC example posed above though here the fixed position opportunities may, in fact, be longer range resources. And by yet another approach, the operational context can comprise communicating via a particular class of wireless point-of-attachment opportunities. To illustrate, it may be appropriate for a given mobile communication station to tend to limit its points of attachment to, for example, only first responder vehicles or only a particular type of public safety vehicle. As another example, this can comprise tending to limit the points of attachment to only mobile points of attachment or to only fixed position points of attachment.

Those skilled in the art will recognize that these examples are intended only to serve an illustrative purpose and are presented without suggesting any particular limitation as to other possibly useful operational contexts that might prove satisfactory in a given setting (aside from the previously mentioned limitation that the operational context itself not comprise a radio frequency environment metric or measure as such).

If desired, the selected opportunity can then be used 103 to facilitate a wireless communication with respect to the mobile communication station. For example, when the selected opportunity comprises a DSRC resource, this selected DSRC resource can then be used to facilitate a DSRC-based wireless communication.

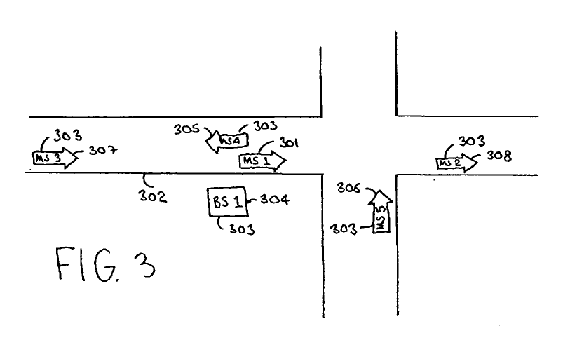

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment, relevant portions of a mobile communication station 200 comprise a selector 201 and a memory 202 that operably couples thereto. The memory 202, by one approach, has stored therein the aforementioned detected plurality of available wireless point-of-attachment opportunities. The selector 201, in this illustrative embodiment, is configured and arranged to select a given one of the plurality of wireless point-of-attachment opportunities as a function, at least in part, of an operational context as corresponds to the mobile communication station to thereby provide at an output thereof a selected wireless point-of-attachment opportunity.

The operational context itself can be provided, if desired, by an operational context source 203. The contents of this source 203 may be dynamically and automatically determined or, if desired, may simply comprise information that an end user has manually entered. Other possibilities exist as well as will be well appreciated by those skilled in the art.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, such a mobile communication station 200 is readily configured and/or programmed to support the teachings set forth above. So configured, for example, this mobile communication station 200 is able to select, when otherwise appropriate, a wireless point-of-attachment opportunity that has less favorable bearer channel conditions than another opportunity when the needs of the operational context are better served by that selection.

Some simple illustrative examples may be useful. Referring now to FIG. 3, a first mobile communication station MS1 301 may be in a vehicle that is moving in a first direction along a road 302. MS1 301 detects, in this example, a number of available wireless point-of-attachment opportunities 303. As suggested by the illustration, most of these opportunities 303 are themselves mobile while one (a DSRC base station BS1 304) comprises a fixed-position platform and remains stationary. It will also be observed that, in this example, some of the opportunities 303 are moving in the same direction as MS1 301, some are moving in the opposite direction, and some are moving orthogonal thereto.

For purposes of this example it is presumed that MS1 301 can also ascertain that there is relatively low relative motion as between MS1 301 and the wireless point-of-attachment opportunities 303 that are moving in the same direction as MS1 301 (these being the two opportunities denoted as MS2 308 and MS3 307). This contrasts, of course, with a relatively higher relative motion as between MS1 301 and the other opportunities 303. Accordingly, a selection to attach to either MS2 308 or MS3 307 can be based upon this observed operational context. Such a selection may, in turn, better serve the medium and long term communication needs of MS1 301 as this platform travels down the road as these points of attachment are more likely to persist for a longer period of time than the other available opportunities.

It should be noted that such a selection can be made notwithstanding that any of MS4 303, MS5 306, and BS1 304 may all be presently offering a higher quality radio frequency environment. Although many prior art approaches would favor a selection of one of these points of attachment (given that higher quality of service metric), the present teachings favor instead a point of attachment that tends to support the tends of a relevant operational context rather than merely a radio frequency environment metric.

These teachings are therefore seen to permit selection of a wireless point-of-attachment opportunity from amongst a plurality of such options as a function of an operational context (at least when at least one of these elements is itself in motion). This, in turn, permits selection of opportunities that are better able to support that operational context and to hence provide potentially better overall service to a given end user. These teachings can be individually applied in a discrete fashion by individual platforms or, if desired, can be leveraged in a context where considerable sharing of information and control strategy is shared amongst potential participants.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a mobile communication station:
detecting a plurality of available wireless point-of-attachment opportunities, wherein at least one of:
the mobile communication station; and
at least one of the plurality of wireless point-of-attachment opportunities; is in motion;
selecting a given one of the plurality of wireless point-of-attachment opportunities as a function, at least in part, of an operational context as corresponds to the mobile communication station to provide a selected wireless point-of-attachment opportunity.

2. The method of claim 1 wherein the mobile communication station comprises one of:
a handheld mobile communication station;
an embedded mobile communication station.

3. The method of claim 1 wherein the mobile communication station is in motion.

4. The method of claim 3 wherein the selected wireless point-of-attachment opportunity is one of:
in motion;
not in motion.

5. The method of claim 3 wherein the selected wireless point-of-attachment opportunity is in motion and wherein there is relatively low relative motion as between the mobile communication station and the selected wireless point-of-attachment opportunity.

6. The method of claim 1 wherein the operational context comprises at least one of:
communicating via wireless point-of-attachment opportunities that comprise relatively short range resources;
communicating with a series of related fixed position wireless point-of-attachment opportunities;
communicating via a particular class of wireless point-of-attachment opportunities.

7. The method of claim 1 wherein selecting a given one of the plurality of wireless point-of-attachment opportunities as a function, at least in part, of an operational context as corresponds to the mobile communication station to provide a selected wireless point-of-attachment opportunity can permissibly comprise selecting a wireless point-of-attachment opportunity that has less favorable bearer channel conditions than another of the plurality of available wireless point-of-attachment opportunities.

8. The method of claim 1 further comprising:
using the selected wireless point-of-attachment opportunity to facilitate a wireless communication.

9. The method of claim 8 wherein using the selected wireless point-of-attachment opportunity to facilitate a wireless communication comprises facilitating a Dedicated Short Range Communication (DSRC).

10. A mobile communication station comprising:
a memory having stored therein a plurality of detected available wireless point-of-attachment opportunities, wherein at least one of:
the mobile communication station; and
at least one of the plurality of wireless point-of-attachment opportunities; is in motion;
a selector that is operably coupled to the memory and that is configured and arranged to select a given one of the plurality of wireless point-of-attachment opportunities as a function, at least in part, of an operational context as corresponds to the mobile communication station to provide a selected wireless point-of-attachment opportunity at an output thereof.

11. The mobile communication station of claim 10 wherein the mobile communication station comprises one of:
a handheld mobile communication station;
an embedded mobile communication station.

12. The mobile communication station of claim 10 wherein the mobile communication station is in motion.

13. The mobile communication station of claim 12 wherein the selected wireless point-of-attachment opportunity is one of:
in motion;
not in motion.

14. The mobile communication station of claim 12 wherein the selected wireless point-of-attachment opportunity is in motion and wherein there is relatively low relative motion as between the mobile communication station and the selected wireless point-of-attachment opportunity.

15. The mobile communication station of claim 10 wherein the operational context comprises at least one of:
communicating via wireless point-of-attachment opportunities that comprise relatively short range resources;
communicating with a series of related fixed position wireless point-of-attachment opportunities;
communicating via a particular class of wireless point-of-attachment opportunities.

16. The mobile communication station of claim 10 wherein the selector comprises means for selecting a given one of the plurality of wireless point-of-attachment opportunities as a function, at least in part, of the operational context as corresponds to the mobile communication station to provide the selected wireless point-of-attachment opportunity.

17. The mobile communication station of claim 16 wherein the means for selecting further comprises means for selecting the wireless point-of-attachment opportunity notwithstanding that the wireless point-of-attachment opportunity has less favorable bearer channel conditions than another of the plurality of available wireless point-of-attachment opportunities.
